(19) United States
(12) Patent Application Publication
(10) Pub. No.: US 2026/0302062 A1
(43) Pub. Date: Oct. 1, 2026

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventors: Daisuke SAKATE, Tokyo (JP); Koichiro MORITA, Tokyo (JP)

(73) Assignee: TAIYO YUDEN CO., LTD., Tokyo (JP)

(21) Appl. No.: 19/577,379

(22) Filed: Mar. 25, 2026

(30) Foreign Application Priority Data
Mar. 27, 2025 (JP) 2025-053846

(51) Int. Cl. H01G 4/12; H01G 4/30

(52) U.S. Cl. CPC H01G 4/12; H01G 4/30

(57) ABSTRACT

A multilayer ceramic electronic device includes at least two internal electrode layers facing each other, and a dielectric layer that is sandwiched by the two internal electrode layers, has a ceramic material as a main component and one or more pores. At least one of the pores extends to the two internal electrode layers.

### CROSS-REFERENCE TO RELATED APPLICATION

This application is based upon and claims the benefit of priority of the prior Japanese Patent Application No. 2025-053846, filed on Mar. 27, 2025, the entire contents of which are incorporated herein by reference.

### FIELD

A certain aspect of the present disclosure relates to a multilayer ceramic electronic device and a manufacturing method of the multilayer ceramic electronic device.

### BACKGROUND

Multilayer ceramic electronic devices such as multilayer ceramic capacitors are widely used as compact, high-capacity, and highly reliable electronic devices. As electronic devices become smaller and their performance improves, there is a demand for even smaller and higher-capacity multilayer ceramic electronic devices. To make more effective use of space within electronic devices, it is expected that thickness will continue to decrease.

### SUMMARY OF THE INVENTION

According to an aspect of the embodiments, there is provided a multilayer ceramic electronic device including: at least two internal electrode layers facing each other; and a dielectric layer that is sandwiched by the two internal electrode layers, has a ceramic material as a main component and one or more pores, wherein at least one of the pores extends to the two internal electrode layers.

According to another aspect of the embodiments, there is provided a manufacturing method of a multilayer ceramic electronic device including: obtaining a multilayer body by stacking a plurality of stack units, each having an internal electrode pattern arranged on a dielectric green sheet containing a first binder with good solubility, a second binder with poor solubility, and a ceramic powder; performing a heat treatment to the multilayer body to remove the first binder and the second binder, and forming a void in a region where the second binder has been removed; and forming a dielectric layer from the dielectric green sheet, forming an internal electrode layer from the internal electrode pattern, and forming a pore from the void, by firing the multilayer body.

According to another aspect of the embodiments, there is provided a manufacturing method of a multilayer ceramic electronic device including: obtaining a multilayer body by stacking a plurality of stack units, each having an internal electrode pattern arranged on a dielectric green sheet containing a carbon material and a ceramic powder; performing a heat treatment to the multilayer body to burn out the carbon material, and forming a void in a region where the carbon material has burned out; and forming a dielectric layer from the dielectric green sheet, forming an internal electrode layer from the internal electrode pattern, and forming a pore from the void by firing the multilayer body.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged cross-sectional views of the vicinity of the external electrodes;

FIG. 5 illustrates a schematic cross-sectional view of a dielectric layer;

FIG. 6 illustrates a schematic cross-sectional view of details of a dielectric layer;

FIG. 7 illustrates a flow of a manufacturing method for a multilayer ceramic capacitor;

FIG. 8A and FIG. 8B illustrate a printing process;

FIG. 9 illustrates a pressurizing and bonding process. ; and

FIG. 10 illustrates attachment of side margins

### DETAILED DESCRIPTION

Reducing the thickness of a multilayer ceramic electronic device reduces its mechanical strength. In this case, for example, bending of the mounting substrate may easily cause cracks to occur in the multilayer ceramic electronic device.

As a solution, one approach to suppress cracking is to impregnate the external electrodes with resin. However, because external electrodes containing resin become thicker, this limits the element size of the multilayer ceramic electronic device.

Hereinafter, an exemplary embodiment will be described with reference to the accompanying drawings.

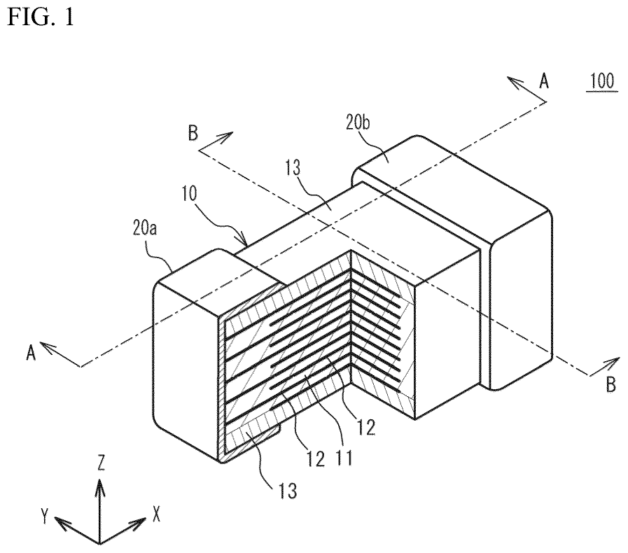

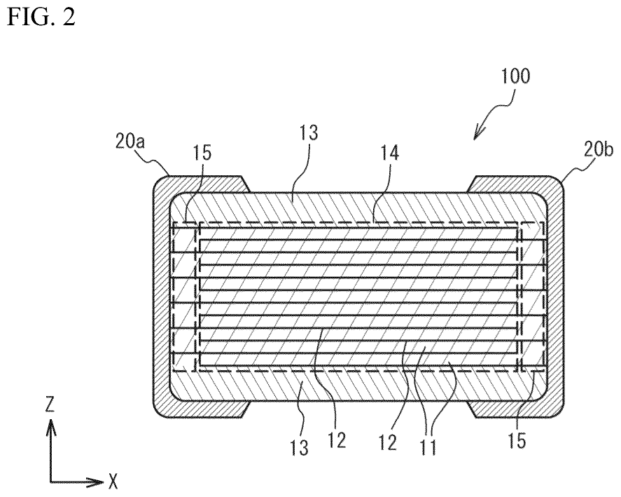

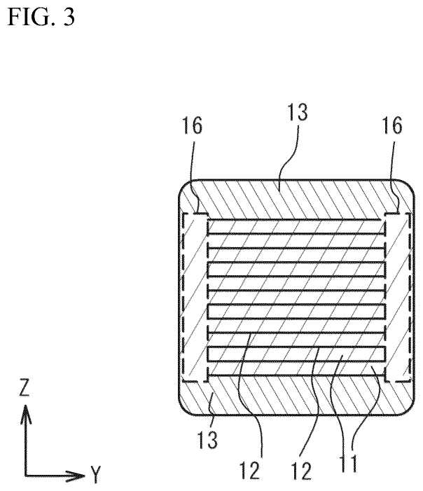

(Embodiment) FIG. 1 illustrates a perspective view of the multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the element body 10. The X-axis direction is a direction in which the two end faces of the element body 10 are opposite to each other and in which the external electrode 20a is opposite to the external electrode 20b. A Y-axis direction (third direction) is a width direction of the internal electrode layers. The Y-axis direction is a direction in which the two side faces of the element body 10 are opposite to each other. The X-axis direction, the Y-axis direction and the Z-axis direction are orthogonal to each other.

The element body 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIG. 1 to FIG. 3, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above-described sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The internal electrode layer 12 may include a ceramic grain such as a co-material. The thickness of the internal electrode layers 12 is, for example, 1.5 μm or less, 1.0 μm or less, or 0.7 μm or less. The thickness of the internal electrode layers 12 can be measured by observing a cross section of the multilayer ceramic capacitor 100 with a scanning electron microscope (SEM), measuring the thickness at 10 points for each of 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1,0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. For example, the dielectric layers 11 contain 90 at % or more of the main component ceramic. The thickness of the dielectric layers 11 is, for example, 0.4 μm or less, or 0.3 μm or less, or 0.2 μm or less. The thickness of the dielectric layers 11 can be measured by observing a cross section of the multilayer ceramic capacitor 100 with a scanning electron microscope (SEM), measuring the thickness at 10 points for each of the 10 different dielectric layers 11, and deriving the average value of all the measurement points.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacitive section 14. That is, the capacitive section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end region 15. The section where the internal electrode layers 12 connected to the external electrode 20b face each other with no internal electrode layer 12 connected to the external electrode 20a interposed therebetween is also the end region 15. That is, the end region 15 is a section where the internal electrode layers 12 connected to one of the external electrodes face each other with no internal electrode layer 12 connected to the other of the external electrodes interposed therebetween. The end region 15 is a section where no capacity is generated.

As illustrated in FIG. 3, in the element body 10, a side region 16 is a section provided so as to cover the ends (ends in the Y-axis direction) of the two side faces of the dielectric layers 11 and the internal electrode layers 12. That is, the side region 16 is a section provided outside the capacitive section 14 in the Y-axis direction. The side region 16 is also a section where no capacity is generated.

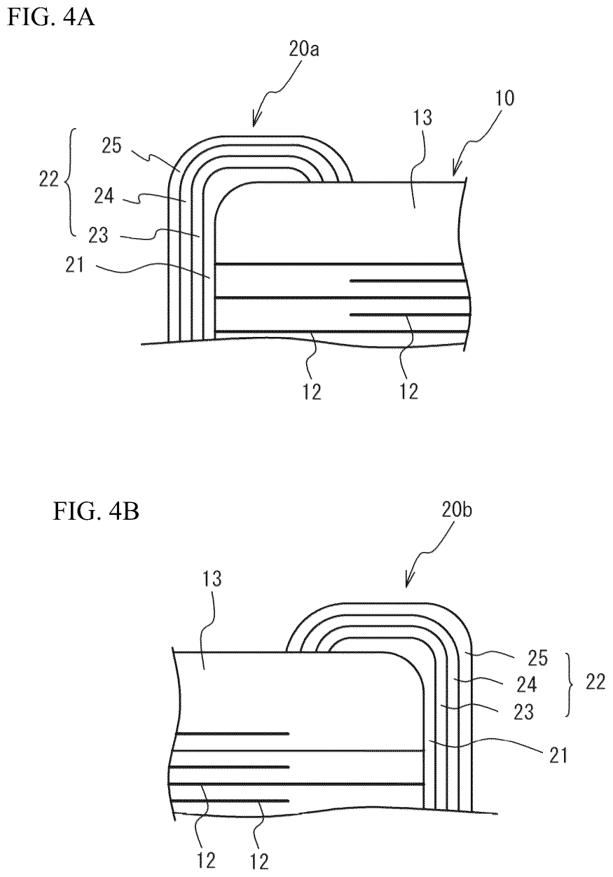

FIG. 4A is an enlarged cross-sectional view of the vicinity of the external electrode 20a. FIG. 4B is an enlarged cross-sectional view of the vicinity of the external electrode 20b. In FIG. 4A and FIG. 4B, hatches are omitted. As illustrated in FIG. 4A and FIG. 4B, the external electrodes 20a and 20b have a structure in which a plated layer 22 is provided on a base layer 21. The base layer 21 is primarily composed of nickel, copper, or the like. The base layer 21 may contain a ceramic grain or a glass component as a co-material. The plated layer 22 is primarily composed of a metal such as nickel, copper, aluminum, zinc, or tin, or an alloy of two or more of these metals. The plated layer 22 may be a plated layer of a single metal component or multiple plated layers of different metal components. For example, the plated layer 22 has a structure in which a first plated layer 23, a second plated layer 24, and a third plated layer 25 are formed in this order from the base layer 21 side. The first plated layer 23 is, for example, a copper plated layer. The second plated layer 24 is, for example, a nickel plated layer. The third plated layer 25 is, for example, a tin plated layer.

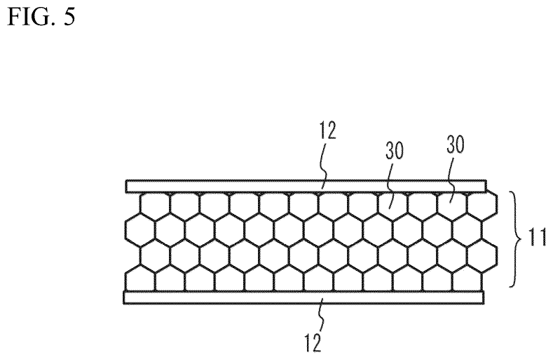

FIG. 5 is a schematic cross-sectional view of the dielectric layer 11. As illustrated in FIG. 5, the dielectric layer 11 has a structure in which a plurality of dielectric grains 30 that constitute the main phase are sintered. For example, only one dielectric grain 30 may exist across the thickness direction. The dielectric layer 11 may have a structure in which the plurality of dielectric grains 30 are continuous through grain boundaries as illustrated in FIG. 5.

The multilayer ceramic capacitor 100 according to this embodiment has a configuration that can suppress the occurrence of cracks. Details are provided below.

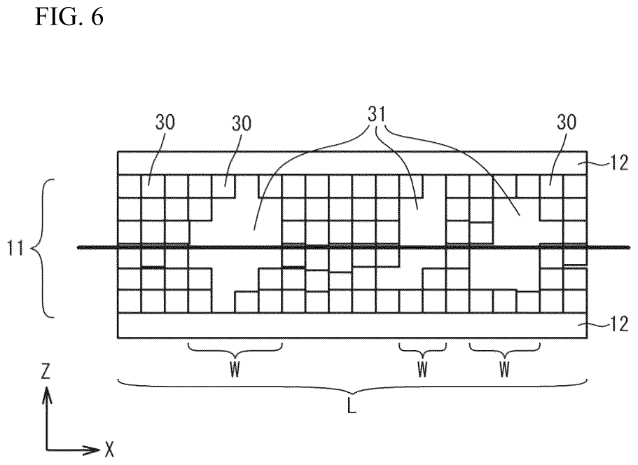

FIG. 6 is a schematic cross-sectional view (XZ cross-section) illustrating details of the dielectric layer 11. As illustrated in FIG. 6, one or more pores 31 are formed in the dielectric layer 11. The pore 31 is a void, which may contain vacuum or gas. Therefore, the pore 31 is distinct from secondary phases formed in the dielectric layer 11.

At least one of the pores 31 extends to the two adjacent internal electrode layers 12. Therefore, at least one of the pores 31 penetrates the dielectric layer 11 in the Z-axis direction. Because stress is absorbed by the pore 31, the occurrence of cracks in the multilayer ceramic capacitor 100 can be suppressed even if, for example, a mounting board is bent.

When the multiple pores 31 are formed, the pores 31 may not necessarily extend to the two adjacent internal electrode layers 12. For example, one of the pores 31 may extend to the one adjacent internal electrode layer 12 but not to the other internal electrode layer 12. Alternatively, one of the pores 31 may reach none of the two adjacent internal electrode layers 12.

If the presence rate of the pores 31 in the dielectric layer 11 is too low, there is a risk that stress will not be sufficiently absorbed. Therefore, it is preferable to set a lower limit for the presence rate of the pores 31. In this embodiment, the 31 presence rate of the pores 31 is preferably 1% or more, more preferably 3% or more, and even more preferably 5% or more.

On the other hand, if the presence rate of the pores 31 in the dielectric layer 11 is too high, the multilayer ceramic capacitor 100 may not necessarily maintain sufficient strength as a multilayer body, and cracks may occur. Therefore, it is preferable to set an upper limit on the presence rate of the pores 31. In this embodiment, the presence rate of the pores 31 is preferably less than 20%, more preferably 15% or less, and even more preferably 10% or less.

Here, the definition of the presence rate of the pores 31 will be explained. The presence rate of the pores 31 (%) can be determined by drawing a straight line in the X-axis direction along the dielectric layer 11 at the center of the dielectric layer 11 in the Z-axis direction in the X-Z cross section, and then calculating the presence rate of the pores 31 (%) on this straight line as follows: (total length W of each pore portion)/(length L of the entire straight line including the dielectric, pores, and so on)×100 (%). When calculating the presence rate of the pores 31 using this definition, the presence rate of the pores 31 may vary depending on the area over which the straight line is drawn. Therefore, an image is acquired using an SEM with the magnification adjusted so that the imaging range in the X-axis direction is 25 μm, and the entire area of the obtained image is used for calculations.

The pores 31 are preferably dispersed throughout the dielectric layer 11. In this embodiment, in an XZ cross section with an imaging range in the X-axis direction of 25 μm, preferably three or more of the pores 31 are formed per layer of the dielectric layer 11, more preferably five or more, and even more preferably ten or more.

Since the thinner layer structure of the dielectric layer 11 is maintained better as the average grain size of the dielectric grains 30 in the dielectric layer 11 decreases, it is preferable to set an upper limit on the average grain size of the dielectric grains 30 in the dielectric layer 11. In this embodiment, the average grain size of the dielectric grains 30 in the dielectric layer 11 is preferably 180 nm or less, more preferably 150 nm or less, and even more preferably 100 nm or less. For example, the average grain size of the dielectric grains 30 is preferably half or less of the thickness of each of the dielectric layers 11. Note that when the average grain size of the dielectric grains 30 is small, large pores are unlikely to form. Therefore, when the average grain size of the dielectric grains 30 is small, the pore 31 extending to the two adjacent internal electrode layers 12 are not formed without special ingenuity.

On the other hand, if the average grain size of the dielectric grains 30 in the dielectric layer 11 is too small, the dielectric constant of the dielectric layer may decrease, resulting in a decrease in capacitance density. Therefore, it is preferable to set a lower limit for the average grain size of the dielectric grains 30 in the dielectric layer 11. In this embodiment, the average grain size of the dielectric grains 30 in the dielectric layer 11 is preferably 50 nm or more, more preferably 80 nm or more, and even more preferably 100 nm or more.

The average grain size of the dielectric grains 30 is measured using an SEM photograph taken near the center of the element body 10 at a high magnification of approximately 40,000×. One of the dielectric layers 11 shown in the photograph is selected, and the average Feret diameter of all the dielectric grains 30 in the selected layer is taken as the average grain size.

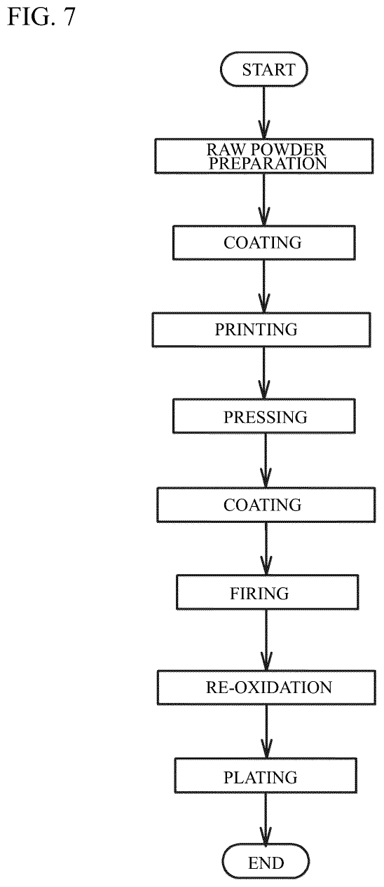

Next, a description will be given of a manufacturing method of the multilayer ceramic capacitors 100. FIG. 7 illustrates a manufacturing method of the multilayer ceramic capacitor 100.

(Preparation process of raw material powder) First, a dielectric material for forming the dielectric layer 11, a cover material for forming the cover layer 13, and a reverse pattern material for forming the side region 16 are prepared. The dielectric material, the cover material, and the reverse pattern material contain barium titanate powder having a perovskite structure. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods have been known for synthesizing barium titanate powder, such as the solid phase method, the sol-gel method, the hydrothermal method, or the like. Any of these methods can be used in this embodiment.

The obtained barium titanate powder is added with a predetermined additive compound depending on the purpose to produce the dielectric material, the cover material, and the reverse pattern material, respectively. As the additive compound, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

(Coating process) Next, a binder such as polyvinyl butyral (PVB) resin, an organic solvent such as ethanol or toluene, and a plasticizer are added to the obtained dielectric material and wet-mixed. Using the obtained slurry, a dielectric green sheet 51 is formed on the substrate by, for example, a die coater method or a doctor blade method, and dried. The substrate is, for example, polyethylene terephthalate (PET) film.

For example, in this embodiment, two or more types of binders are used as the binder. The first binder has good solubility and is easy to adjust viscosity, drying characteristics, and sintered residue. For example, polyvinyl butyral (PVB) resin is one example. The second binder has poor solubility. For example, polytetrafluoroethylene is one example.

The second binder remains as agglomerates. These clumps of the second binder are removed by the heat treatment reaction described below, forming the voids mentioned above. For example, the second binder is added in powder form. The diameter of this powder is preferably about the same as the thickness of the dielectric green sheet 51. For example, the second binder is preferably between 1 wt % and 5 wt %, assuming the total binder amount to be 100 wt %.

Alternatively, carbon powder may be added to the dielectric green sheet 51. The carbon powder reacts with oxygen during the heat treatment described below, volatilizing as carbon dioxide or carbon monoxide, forming voids. The diameter of the carbon powder is preferably about the same as the thickness of the dielectric green sheet 51. For example, when the total amount of raw material powder is taken as 100 wt %, it is preferably 1 wt % or more and 5 wt % or less. Since it is preferable that the carbon powder has poor dispersibility, it is preferable to use amorphous carbon or the like.

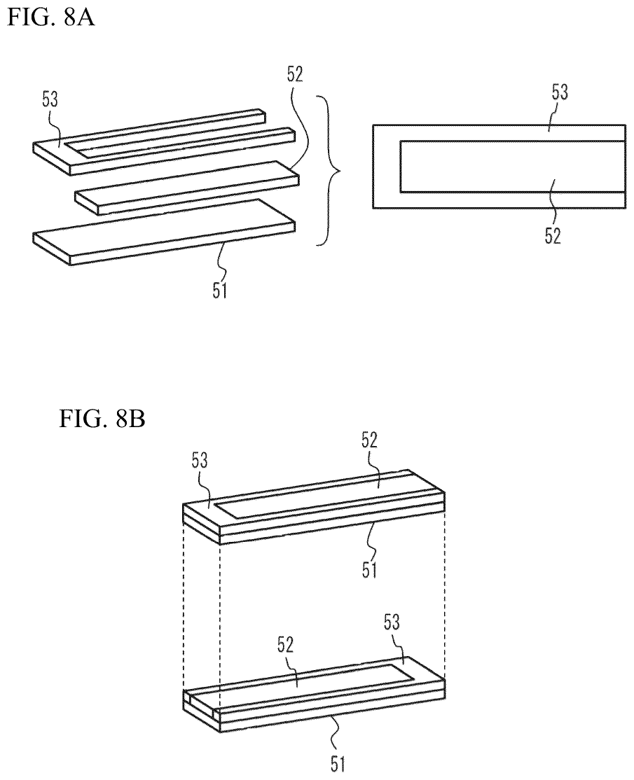

(Printing process) Next, as illustrated in FIG. 8A, a metal conductive paste for forming internal electrodes containing an organic binder is printed on the surface of the dielectric green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11. For example, barium titanate having an average particle size of 50 nm or less may be uniformly dispersed.

Next, a binder such as ethyl cellulose and an organic solvent such as terpineol are added to the dielectric pattern material obtained in the preparation process of the raw material powder, and the mixture is kneaded in a roll mill to form a dielectric pattern paste for the mask pattern layer. As illustrated in FIG. 8A, a dielectric pattern 53 is formed by printing the resulting slurry in the peripheral region, where the internal electrode pattern 52 is not printed, on the dielectric green sheet 51 to cause the dielectric pattern 53 and the internal electrode pattern 52 to form a flat surface. The dielectric green sheet 51 on which the internal electrode pattern 52 and the dielectric pattern 53 are printed is referred to as a stack unit.

Thereafter, as illustrated in FIG. 8B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 to 1000.

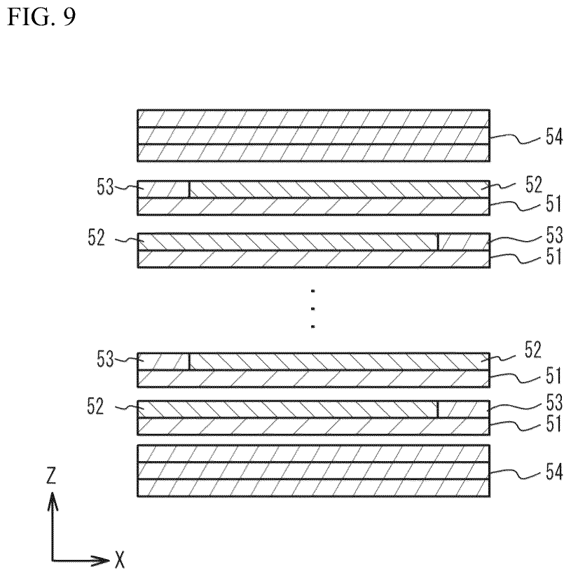

(Pressing process) Next, a binder such as an ethyl cellulose-based binder and an organic solvent such as a terpineol-based binder are added to the cover material and kneaded in a roll mill to obtain a cover sheet 54. As illustrated in FIG. 9, a predetermined number of the cover sheets 54 are stacked on top and bottom of a multilayer body in which the stack units are stacked, and then pressed and bonded. The stack body is then cut to a predetermined chip size (for example, 1.0 mm×0.5 mm).

(Firing Process) The ceramic multilayer body obtained in this manner is subjected to a binder removal process (heat treatment) in an N₂ atmosphere, air atmosphere, or the like. If the first and second binders described above are added to the dielectric green sheet 51, voids will form where the second binder has been removed. A metal paste that will form the base layer of the external electrodes 20a, 20b is then applied by dipping. The multilayer body is then held at approximately 1200° C. for approximately one hour in a reducing atmosphere with an oxygen partial pressure of 10⁻¹⁰ to 10⁻¹² atm to sinter the ceramic particles. Subsequently, without lowering the temperature, the multilayer body is fired in a reducing atmosphere with an oxygen partial pressure of 10⁻⁸ to 10⁻⁹ atm at a temperature ranging from 1250° C. to 1300° C. for four to six hours. In this manner, the multilayer ceramic capacitor 100 is obtained. Note that the pores 31 are formed from the voids.

(Other Firing Process) If the above-mentioned carbon powder is added to the dielectric green sheet 51, after the binder removal process, the sheet is held at 700° C. to 800° C. for 3 to 4 hours in a reducing atmosphere with an oxygen partial pressure of 10⁻⁶ to 10⁻³ atm to burn out the carbon powder and form voids. The sheet is then held at approximately 1200° C. for approximately 1 hour in a reducing atmosphere with an oxygen partial pressure of 10⁻¹⁰ to 10⁻¹² atm to sinter the ceramic particles. Subsequently, without lowering the temperature, the sheet is fired in a reducing atmosphere with an oxygen partial pressure of 10⁻⁸ to 10⁻⁹ atm at a temperature ranging from 1250° C. to 1300° C. for 4 to 6 hours. In this manner, the multilayer ceramic capacitor 100 is obtained. The voids form the pores 31.

(Re-oxidation process) In order to return oxygen to the barium titanate, which is the partially reduced main phase of the dielectric layer 11 fired in a reducing atmosphere, heat treatment may be performed in a mixed gas of N₂ and water vapor at about 1000° C. or in the air at 500° C. to 700° C., to the extent that the internal electrode layer 12 is not oxidized. This process is called a re-oxidation process.

(Plating process) After that, metal layers such as copper, nickel, and tin may be formed on the base layers of the external electrodes 20a and 20b by plating. Thus, the multilayer ceramic capacitor 100 is manufactured.

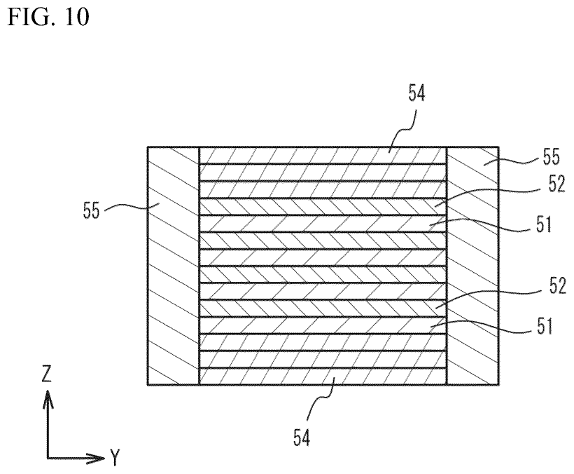

The side margins may be attached or applied to the side faces of the multilayer portion. Specifically, as illustrated in FIG. 10, the multilayer portion is obtained by alternately stacking the dielectric green sheets 51 and the internal electrode patterns 52 of the same width as the dielectric green sheets 51. Next, a sheet formed from a dielectric pattern paste may be attached to the side faces of the multilayer portion as side margins 55.

In the above embodiments, a multilayer ceramic capacitor has been described as an example of a multilayer ceramic electronic device, but this is not limiting. For example, other multilayer ceramic electronic devices such as varistors and thermistors may also be used.

Although the embodiments of the present invention have been described in detail, it is to be understood that the various changes, substitutions, and alterations could be made hereto without departing from the spirit and scope of the invention.

What is claimed is:

1. A multilayer ceramic electronic device comprising:
at least two internal electrode layers facing each other; and
a dielectric layer that is sandwiched by the two internal electrode layers, has a ceramic material as a main component and one or more pores,
wherein at least one of the pores extends to the two internal electrode layers.

2. The multilayer ceramic electronic device as claimed in claim 1,
wherein, in the dielectric layer, a presence rate of the one or more pores is less than 20%, and
wherein, when a direction in which the two internal electrode layers face each other is a first direction and a direction orthogonal to the first direction is a second direction, the presence rate is calculated by drawing a straight line in the second direction at a center of the dielectric layer in the first direction in a cross section including the first direction and the second direction, and then calculating “total length of the one or more pores”/“a length of an entire of the straight line including dielectric and the one or more pores”×100% on the straight line.

3. The multilayer ceramic electronic device as claimed in claim 1,
wherein, in the dielectric layer, the presence rate of the one or more pores is 1% or more, and
wherein, when a direction in which the two internal electrode layers face each other is a first direction and a direction orthogonal to the first direction is a second direction, the presence rate is calculated by drawing a straight line in the second direction at a center of the dielectric layer in the first direction in a cross section including the first direction and the second direction, and then calculating “total length of the one or more pores”/“a length of an entire of the straight line including dielectric and the one or more pores”×100% on the straight line.

4. The multilayer ceramic electronic device as claimed in claim 1,
wherein the dielectric layer includes a plurality of dielectric grains including the ceramic material, and
wherein an average grain size of the plurality of dielectric grains is 180 nm or less.

5. The multilayer ceramic electronic device as claimed in claim 1,
wherein the dielectric layer includes a plurality of dielectric grains including the ceramic material, and
wherein an average grain size of the plurality of dielectric grains is 50 nm or more.

6. The multilayer ceramic electronic device as claimed in claim 1,
wherein the dielectric layer includes a plurality of dielectric grains of the ceramic material, and
wherein the dielectric layer has a structure in which at least two of the plurality of dielectric grains are continuous in a thickness direction of the dielectric layer via a grain boundary.

7. A manufacturing method of a multilayer ceramic electronic device comprising:
obtaining a multilayer body by stacking a plurality of stack units, each having an internal electrode pattern arranged on a dielectric green sheet containing a first binder with good solubility, a second binder with poor solubility, and a ceramic powder;
performing a heat treatment to the multilayer body to remove the first binder and the second binder, and forming a void in a region where the second binder has been removed; and
forming a dielectric layer from the dielectric green sheet, forming an internal electrode layer from the internal electrode pattern, and forming a pore from the void, by firing the multilayer body.

8. A manufacturing method of a multilayer ceramic electronic device comprising:
obtaining a multilayer body by stacking a plurality of stack units, each having an internal electrode pattern arranged on a dielectric green sheet containing a carbon material and a ceramic powder;
performing a heat treatment to the multilayer body to burn out the carbon material, and forming a void in a region where the carbon material has burned out; and
forming a dielectric layer from the dielectric green sheet, forming an internal electrode layer from the internal electrode pattern, and forming a pore from the void by firing the multilayer body.
